(19) United States
(12) Patent Application Publication
(10) Pub. No.: US 2022/0229884 A1
(43) Pub. Date: Jul. 21, 2022

(54) URL MANAGEMENT IN IMAGE FORMING APPARATUS

(71) Applicant: Hewlett-Packard Development Company, L.P., Spring, TX (US)

(72) Inventors: Jungjin PARK, Seongnam-si (KR); Woohyun CHO, Seongnam-si (KR); Hyoungdong CHOI, Seongnam-si (KR)

(21) Appl. No.: 17/605,118

(22) PCT Filed: May 19, 2020
(86) PCT No.: PCT/US2020/033565

§ 371 Date: Oct. 20, 2021

(30) Foreign Application Priority Data
Nov. 28, 2019 (KR) 10-2019-0155739

(51) Int. Cl. G06F 21/12; G06F 3/12

(52) U.S. Cl. CPC G06F 21/128; G06F 3/1287; G06F 3/1222; G06F 3/1203; G06F 3/1258; G06F 3/1239

(57) ABSTRACT

An example image forming apparatus comprises a user interface device, a processor, and a memory storing instructions executable by the processor. The processor executes the instructions to perform a reliability determination for a uniform resource locator (URL) of a web page to be accessed according to execution of an application, provide a reliability determination result for the URL through the user interface device, and manage a URL list of URLs based on the reliability determination result, the URLs included in the URL list having recognized reliability.

### BACKGROUND

An image forming apparatus such as a multi-function printer supports functions such as printing, scanning, copying, faxing, and the like. To expand the functions of an image forming apparatus, a user may install an application, which is provided by a third party or the vendor of the image forming apparatus, in the image forming apparatus. When the application is installed in the image forming apparatus, the image forming apparatus may have information about a uniform resource locator (URL) of a web page, which is used for execution of the application, to provide normal service of the application and to maintain the security thereof.

### BRIEF DESCRIPTION OF DRAWINGS

Various examples will be described below by referring to the following figures.

FIG. 1 is a diagram for describing an image forming apparatus, a user terminal, a cloud server, and a server in an environment in which an application installed in the image forming apparatus is executed, according to an example.

FIG. 2 is a diagram for describing an application service provided by a cloud server after a web page, which the cloud server requests an image forming apparatus to access, is accessed according to execution of the application in the image forming apparatus, according to an example.

FIG. 3 is a block diagram for describing an image forming apparatus, according to an example.

FIG. 4 is a diagram for describing an operation of a processor of an image forming apparatus, according to an example.

FIG. 5 is a diagram for describing an operation of an image forming apparatus, a cloud server, and an external server, according to an example.

FIG. 6 is a flowchart of a uniform resource locator (URL) management method in an image forming apparatus, according to an example.

FIG. 7 is a flowchart of a procedure for performing reliability determination for a URL of a web page, according to an example.

FIG. 8 is a flowchart of a procedure for providing a reliability determination result for a URL of a web page, according to an example.

### DETAILED DESCRIPTION OF EXAMPLES

Hereinafter, various examples will be described with reference to the drawings. In the specification and drawings, like elements having substantially the same functional configurations are denoted by like reference numerals, and thus their description will be omitted.

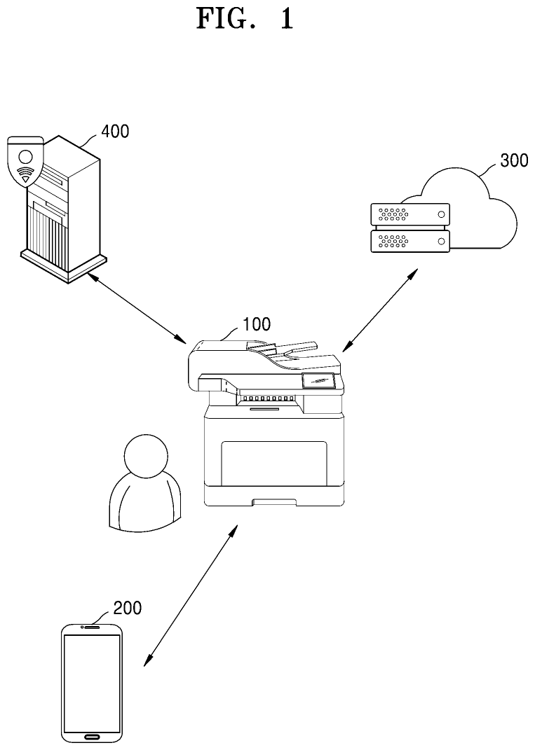

FIG. 1 is a diagram for describing an image forming apparatus, a user terminal, a cloud server, and an external server in an environment in which an application installed in the image forming apparatus is executed, according to an example.

Referring to FIG. 1, an image forming apparatus 100 generically refers to a device such as a printer, a copier, a multi-function printer, and a fax machine, which performs an image forming job. The image forming job may refer to any one of various jobs involving an image, e.g., printing, copying, scanning, faxing, or a function connected with any one of them, and may comprise a series of processes necessary for the execution of the image forming job.

Various applications may be installed in the image forming apparatus 100, and a user may execute an application corresponding to a desired function among the various applications. For example, a user may use a default function of the image forming apparatus 100, such as printing, scanning, copying, faxing, or the like, by executing a default application corresponding to the default function. To expand the functions supported by the image forming apparatus 100, a user may install and execute an application in the image forming apparatus 100, wherein the application is provided by a third party or the vendor of the image forming apparatus 100. The function of such an application may be executed through a cloud server 300 of the provider of a corresponding service. At this time, the image forming apparatus 100 may be requested to access a web page provided by the cloud server 300. For example, execution of the function through the cloud server 300 may include logging in via a log-in page based on a web page provided by the cloud server 300. Information such as a uniform resource locator (URL) of a web page that needs to be accessed to execute an application may be provided to a user at the time of distribution of the application, and the user may register the URL as reliable in the image forming apparatus 100.

A user terminal 200 may comprise a computing device such as a smartphone, a notebook personal computer, or the like. The user terminal 200 may comprise an input unit to obtain a user input and an output unit to provide information for the user. The user terminal 200 may be connected to an external device through a communication interface device. A user or a manager of the image forming apparatus 100 may operate the image forming apparatus 100 not only directly but also through the user terminal 200. The user may input various kinds of information to the image forming apparatus 100 through the user terminal 200.

The cloud server 300 supports a service provided by an application executed by the image forming apparatus 100. When there is a request from an application executed by the image forming apparatus 100, the cloud server 300 may provide a response corresponding to the request. For example, when an application executed by the image forming apparatus 100 requests the cloud server 300 to perform a certain process to provide a service, the cloud server 300 may directly perform the process or may use an external device to perform the process.

An external server 400 may provide a certain service. The external server 400 may be outside the image forming apparatus 100 and may communicate with the image forming apparatus 100. When the image forming apparatus 100 requests a certain service, the external server 400 may provide the certain service for the image forming apparatus 100. For example, the external server 400 may provide a reliability determination service with respect to a URL of a web page.

The external server 400 providing the reliability determination service may determine whether the URL of a web page is reliable, that is, whether it is safe to access a web page using a URL of the web page. For example, the external server 400 providing the reliability determination service may manage a blacklist of URLs of web pages including malware, phishing content, etc., determine whether a URL of a web page, for which reliability determination is requested, is included in the blacklist, and provide a result of the determination. In another example, the external server 400 providing the reliability determination service may manage a white list of URLs of reliable web pages, determine whether a URL of a web page, for which reliability determination is requested, is included in the white list, and provide a result of the determination.

In the example of FIG. 1, a user may execute an application installed in the image forming apparatus 100 directly or remotely through the user terminal 200. According to the execution of the application, the image forming apparatus 100 may be requested to access a web page provided by the cloud server 300 that supports a service of the application. Before accessing and loading the web page, the image forming apparatus 100 may perform a reliability determination for a URL of the web page, which the cloud server 300 requests the image forming apparatus 100 to access. For the reliability determination, the image forming apparatus 100 may request the external server 400 outside the image forming apparatus 100 to perform the reliability determination for the URL of the web page, wherein the external server 400 provides reliability determination services with respect to URLs of web pages. Based on the reliability determination result received from the external server 400, the image forming apparatus 100 may access the URL of the web page or block access to the URL of the web page.

The names of the elements of the image forming apparatus 100, the user terminal 200, the cloud server 300, and the external server 400, may vary. Each of these devices may comprise at least one of the elements. Some of the elements may be omitted, or other elements may be added to each of these devices.

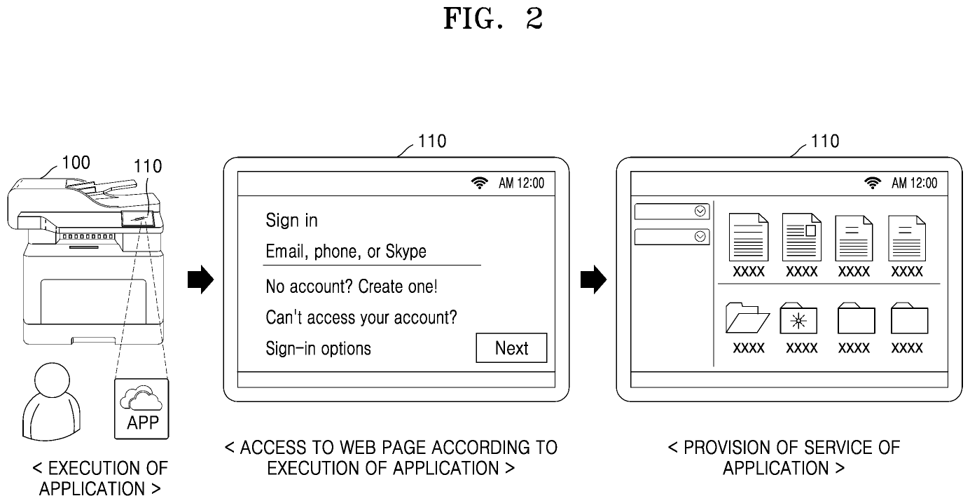

FIG. 2 is a diagram for describing an application service provided by a cloud server after a web page, which the cloud server requests an image forming apparatus to access, is accessed according to execution of the application in the image forming apparatus, according to an example.

Referring to FIG. 2, when a user executes an application in the image forming apparatus 100, access to a web page may be requested by the cloud server 300, which supports a service of the application, before the service of the application is provided, wherein the web page is provided by the cloud server 300. For example, as shown in FIG. 2, access to a log-in page may be requested using a user interface device 110, wherein the log-in page is based on a web page provided by the cloud server 300. However, since a URL of the web page, to which the access is requested for execution of the application, is provided in advance at the time of distribution of the application, the image forming apparatus 100 may have registered the URL as reliable. Accordingly, when access to the web page provided by the cloud server 300 is requested by the cloud server 300, the access to the web page may be immediately enabled because the URL of the web page has been registered as reliable. Thereafter, as shown in FIG. 2, when a log-in procedure is performed via the log-in page based on the web page provided by the cloud server 300, the service of the application may be provided through the cloud server 300.

The cloud server 300 supporting the service of the application may change the URL of the web page, which is accessed according to the execution of the application, to a new URL, and the old URL may be redirected to the new URL. When information about a changed URL has not been notified or the changed URL has not been registered in a list of reliable URLs in the image forming apparatus 100, access to the changed URL is blocked in the image forming apparatus 100. For example, when a log-in page based on a web page used to be provided through a first URL but is now provided through a second URL and the image forming apparatus 100 has not registered the second URL as reliable, access to the second URL is blocked even if the second URL is reliable. An example method is described below of managing a URL of a web page accessed according to execution of an application in the image forming apparatus 100 such that, when access to a new URL is requested, the security of the image forming apparatus 100 is maintained without causing an inconvenience of blocking a user's access to the new URL.

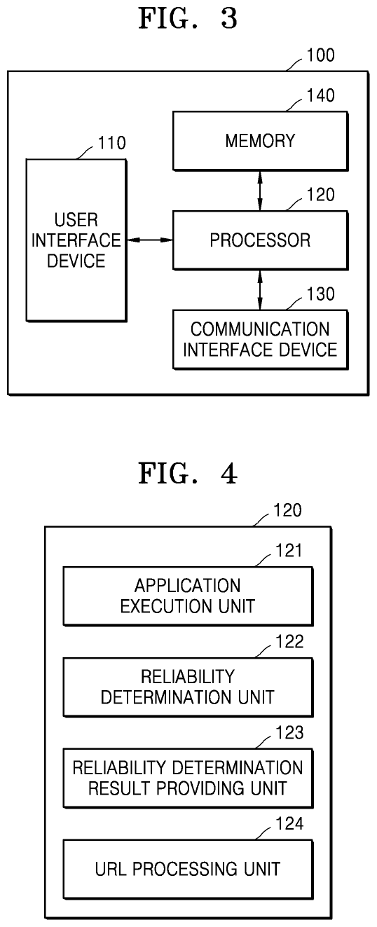

FIG. 3 is a block diagram for describing an image forming apparatus, according to an example.

Referring to FIG. 3, the image forming apparatus 100 may comprise a user interface device 110, a processor 120, a communication interface device 130, and a memory 140. Although not shown, the image forming apparatus 100 may further comprise an image forming job unit and a power unit to supply power to other elements.

The user interface device 110 may comprise an input unit to receive an input for performing an image forming job from a user, and an output unit, to display a result of performing the image forming job or information such as a state of the image forming apparatus 100.

The processor 120 may control an operation of the image forming apparatus 100 and may comprise at least one processor such as a central processing unit (CPU). The processor 120 may control the elements of the image forming apparatus 100 to perform an operation corresponding to a user input received through the user interface device 110. The processor 120 may comprise at least one specialized processor corresponding to a certain function. The processor 120 may execute a program stored in the memory 140, read data or a file from the memory 140, or store a new program or application in the memory 140.

The communication interface device 130 may communicate with other devices or networks via wired or wireless connection. For this communication, the communication interface device 130 may comprise a communication module (e.g., a transceiver) supporting at least one of various wired/wireless communication methods. The communication interface device 130 may be connected to an external device outside the image forming apparatus 100 and may transmit and receive signals or data. Referring to FIG. 3, the image forming apparatus 100 may be connected to the user terminal 200, the cloud server 300, and the external server 400 through the communication interface device 130.

Various kinds of data, such as an application, a program, and a file, may be stored in the memory 140. The processor 120 may access and use data stored in the memory 140 or may store new data in the memory 140. The processor 120 may install and execute a program, which is stored in the memory 140, in the image forming apparatus 100. The processor 120 may also install an application, which is externally received through the communication interface device 130, in the image forming apparatus 100.

For functions executable by the image forming apparatus 100, there is an application, which is installed in the image forming apparatus 100 at the time of manufacture of the image forming apparatus 100, and an application, which is developed by a third party or the vendor of the image forming apparatus 100 and installed in the image forming apparatus 100 after manufacture of the image forming apparatus 100.

The image forming job unit (not shown) may perform an image forming job such as copying, printing, scanning, or faxing. The image forming job unit may form an image on a print medium using various printing methods. The image forming job unit may radiate light to a document and collect light reflected from the document, thereby reading an image recorded on the document. The image forming job unit may share a configuration for scanning an image with a scanning unit, may share a configuration for printing a received file with a printing unit, and may transmit a scanned file to a destination or receive a file from outside the image forming apparatus 100.

For the management of a URL of a web page in the image forming apparatus 100, the processor 120 may execute instructions stored in the memory 140 to perform a reliability determination for the URL of the web page, which is accessed according to execution of an application by the image forming apparatus 100. At this time, the URL of the web page accessed according to execution of the application by the image forming apparatus 100 may include a new URL changed by the cloud server 300 that supports the service of the application.

The image forming apparatus 100 may determine whether the URL of the web page accessed according to the execution of the application by the image forming apparatus 100 is included in a URL list. When the URL of the web page is not included in the URL list, the image forming apparatus 100 may request the external server 400, which provides a reliability determination service, to determine the reliability of the URL, and may receive, as a response to the request, a reliability determination result from the external server 400 through the communication interface device 130.

The processor 120 may provide the reliability determination result for the URL of the web page, which is accessed according to the execution of the application by the image forming apparatus 100, through the user interface device 110. When the reliability of the URL of the web page accessed according to the execution of the application by the image forming apparatus 100 is not recognized, the processor 120 may display an error message, which indicates that the web page is not accessible, through the user interface device 110. When the reliability of the URL of the web page accessed according to the execution of the application by the image forming apparatus 100 is recognized, the processor 120 may display a notification message, which indicates that the URL having the recognized reliability is registered in the URL list, through the user interface device 110.

The processor 120 may manage the URL list, of which the reliability has been recognized, based on the reliability determination result for the URL of the web page accessed according to the execution of the application by the image forming apparatus 100. When the reliability of the URL of the web page accessed according to the execution of the application by the image forming apparatus 100 is recognized, the processor 120 may register the URL in the URL list stored in the image forming apparatus 100. The processor 120 may register a URL in the URL list automatically or according to a user input. The processor 120 may reset the URL list at certain intervals. The processor 120 may reset, at certain intervals, at least one URL in the URL list. All or some URLs in the URL list may be selectively reset. A URL registered within a certain time (e.g., in the last few days) may be deleted from the URL list at certain intervals. A lifespan may be given to a URL at the time of registering the URL in the URL list, and the URL may be set to be deleted from the URL list when the lifespan expires. This is because the reliability of a URL may not be maintained over time even when the URL has been registered in the URL list.

FIG. 4 is a diagram for describing an operation of a processor of an image forming apparatus, according to an example.

Referring to FIG. 4, the processor 120 may comprise sub modules to perform various functions. While four sub-modules are illustrated in FIG. 4, the sub modules may be subdivided further, and examples are not limited thereto.

When a request for execution of an application installed in the image forming apparatus 100 is received, an application execution unit 121 of the processor 120 may execute the application. The application execution unit 121 may display a result of accessing the cloud server 300, which supports a service of the application, through a web browser, a web viewer, or the like.

A reliability determination unit 122 of the processor 120 may determine whether a URL of a web page that is accessed according to the execution of the application by the image forming apparatus 100 is a new URL or an existing URL having the reliability recognized. When the URL of the web page is an existing URL, the reliability determination unit 122 may allow the application execution unit 121 to access the cloud server 300 through a web browser, a web viewer, or the like. When the URL of the web page is a new URL of which the reliability has not been recognized, the reliability determination unit 122 may request the external server 400 to perform a reliability determination for the new URL. In an example, information about the external server 400 that provides a reliability determination service may be input in advance, such as by a user or a manager of the image forming apparatus 100. The reliability determination unit 122 of the processor 120 may receive a result of determining whether the new URL is a reliable web page or a malicious web page from the external server 400 that provides the reliability determination service.

Based on the reliability determination result received from the reliability determination unit 122, a reliability determination result providing unit 123 of the processor 120 may generate an error message indicating that the web page is inaccessible and display the error message through the user interface device 110 when the reliability of the URL is not recognized and may display a notification message, which indicates that the URL is registered in a URL list, through the user interface device 110 when the reliability of the URL is recognized.

A URL processing unit 124 of the processor 120 may manage the URL list having the recognized reliability based on a reliability determination result for a URL. When the reliability of a URL of a web page accessed according to the execution of an application is recognized, the URL processing unit 124 of the processor 120 may register the URL in the URL list stored in the image forming apparatus 100. The processor 120 may register the URL in the URL list automatically or according to a user input.

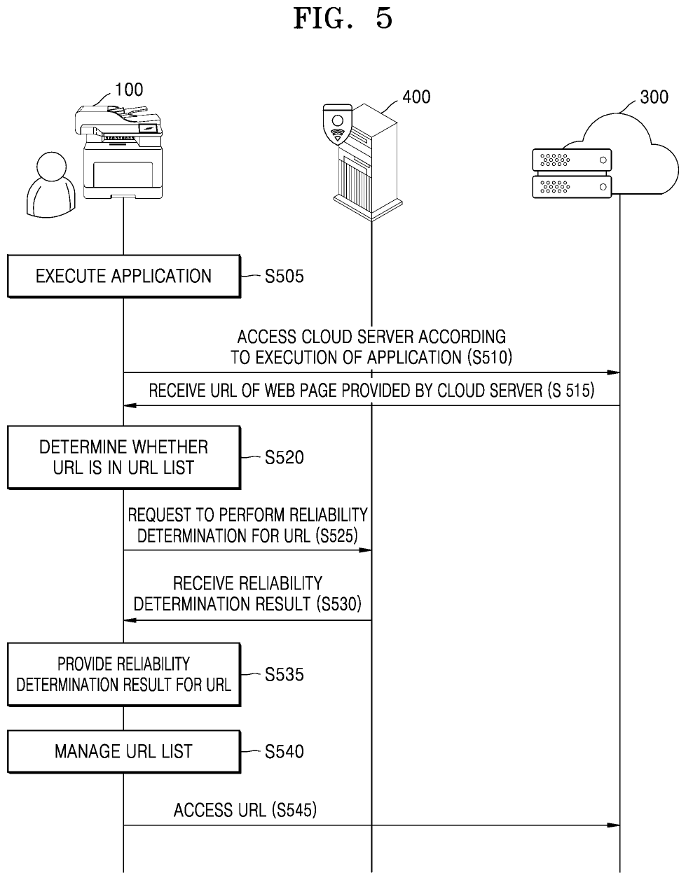

FIG. 5 is a diagram for describing an operation of an image forming apparatus, a cloud server, and an external server, according to an example.

Referring to FIG. 5, the image forming apparatus 100 may execute an application in response to a user's direct input or a request from the user terminal 200 in operation S505.

The image forming apparatus 100 may access the cloud server 300 according to the execution of the application by the image forming apparatus 100 in operation S510.

The image forming apparatus 100 may receive a URL of a web page provided by the cloud server 300 in operation S515.

The image forming apparatus 100 may determine whether the URL of the web page accessed according to the execution of the application by the image forming apparatus 100 is included in a URL list of URLs having recognized reliability in operation S520.

When the URL of the web page accessed according to the execution of the application by the image forming apparatus 100 is not in the URL list, the image forming apparatus 100 may request the external server 400, which provides a reliability determination service, to perform a reliability determination for the URL of the web page accessed according to the execution of the application by the image forming apparatus 100 in operation S525.

The image forming apparatus 100 may receive a reliability determination result from the external server 400 as a response to the request for the reliability determination for the URL of the web page accessed according to the execution of the application by the image forming apparatus 100 in operation S530.

The image forming apparatus 100 may provide the reliability determination result for the URL of the web page accessed according to the execution of the application by the image forming apparatus 100 in operation S535.

The image forming apparatus 100 may manage the URL list of URLs having recognized reliability based on the reliability determination result for the URL of the web page accessed according to the execution of the application by the image forming apparatus 100 in operation S540. When the reliability of the URL of the web page accessed according to the execution of the application by the image forming apparatus 100 is recognized, the image forming apparatus 100 may register the URL in the URL list stored therein.

The image forming apparatus 100 may access the URL of the web page accessed according to the execution of the application by the image forming apparatus 100, wherein the reliability of the URL has been recognized in operation S545.

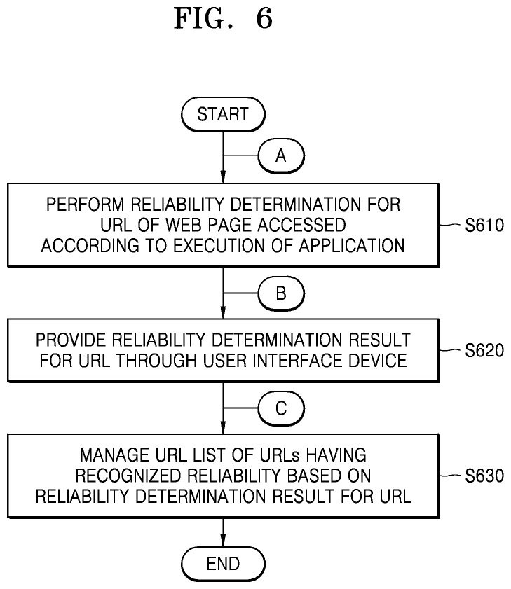

FIG. 6 is a flowchart of a URL management method in an image forming apparatus, according to an example.

Referring to FIG. 6, the image forming apparatus 100 may perform a reliability determination for a URL of a web page accessed according to execution of an application in operation S610. At this time, the URL may have been changed by the cloud server 300 that supports a service of the application.

The image forming apparatus 100 may provide a reliability determination result for the URL of the web page accessed according to the execution of the application by the image forming apparatus 100 through the user interface device 110 in operation S620.

The image forming apparatus 100 may manage the URL list of URLs having recognized reliability based on the reliability determination result for the URL of the web page accessed according to the execution of the application by the image forming apparatus 100 in operation S630. When the reliability of the URL of the web page accessed according to the execution of the application by the image forming apparatus 100 is recognized, the image forming apparatus 100 may register the URL in the URL list stored therein. The image forming apparatus 100 may register the URL in the URL list automatically or according to a user's input.

The image forming apparatus 100 may reset, at certain intervals, at least one URL in the URL list.

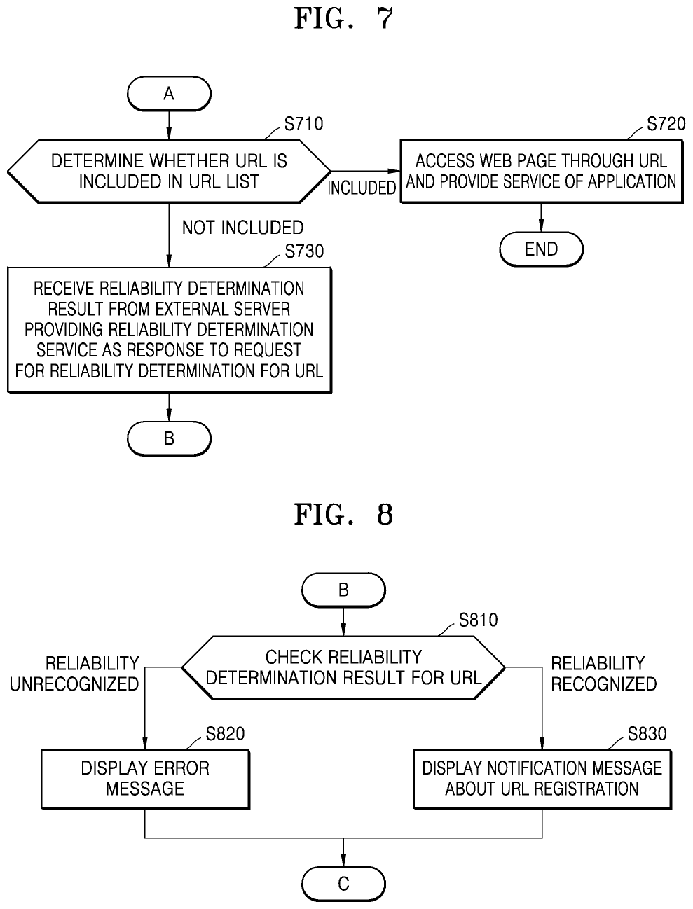

FIG. 7 is a flowchart of a procedure for performing reliability determination for a URL of a web page, according to an example.

Referring to FIG. 7, the image forming apparatus 100 may determine whether a URL of a web page accessed according to execution of an application by the image forming apparatus 100 is included in a URL list of URLs having recognized reliability in operation S710. When the URL of the web page accessed according to the execution of the application by the image forming apparatus 100 is included in the URL list, it indicates that the URL of the web page accessed according to the execution of the application by the image forming apparatus 100 is not a new one but has recognized reliability, and therefore, the image forming apparatus 100 may immediately access the URL of the web page.

When the URL of the web page accessed according to the execution of the application by the image forming apparatus 100 is included in the URL list, the image forming apparatus 100 may access the web page through the URL of the web page and provide a service of the application in operation S720.

When the URL of the web page accessed according to the execution of the application by the image forming apparatus 100 is not included in the URL list, the image forming apparatus 100 may receive a reliability determination result from the external server 400 as a response to a request for the external server 400 to perform a reliability determination for the URL of the web page in operation S730.

FIG. 8 is a flowchart of a procedure for providing a reliability determination result for a URL of a web page, according to an example.

Referring to FIG. 8, the image forming apparatus 100 may check a reliability determination result for a URL of a web page accessed according to execution of an application in operation S810.

When the reliability of the URL of the web page accessed according to the execution of the application by the image forming apparatus 100 is not recognized, the image forming apparatus 100 may display an error message, which indicates that the web page is not accessible, through the user interface device 110 in operation S820.

When the reliability of the URL of the web page accessed according to the execution of the application by the image forming apparatus 100 is recognized, the image forming apparatus 100 may display a notification message, which indicates that the URL having the recognized reliability is registered in the URL list, through the user interface device 110 in operation S830.

The examples of a URL management method in the image forming apparatus 100 may be provided as computer programs which are stored in a computer-readable storage medium to enable the image forming apparatus 100 to execute each stage in the method.

The example methods of managing a URL in an image forming apparatus may be embodied as non-transitory computer-readable storage media that store data or commands executable by a computer or a processor. The methods may be written as computer programs and can be implemented in general-use digital computers that execute the programs using a non-transitory computer readable storage medium. The non-transitory computer-readable storage media may be read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tape, floppy disks, magneto-optical data storage devices, optical data storage devices, hard disks, solid state disks (SSDs), or any devices that can store a command or software, relevant data, a data file, and a data structure and can provide the command or software, the relevant data, the data file, and the data structure to a processor or a computer to allow the processor or computer to execute the command.

What is claimed is:

1. An image forming apparatus comprising:
a user interface device;
a processor; and
a memory storing instructions executable by the processor,
wherein the processor is to execute the instructions to:
perform a reliability determination for a uniform resource locator (URL) of a web page to be accessed according to execution of an application,
provide a reliability determination result for the URL through the user interface device, and
manage a URL list of URLs based on the reliability determination result, wherein the URLs included in the URL list have recognized reliability.

2. The image forming apparatus of claim 1, wherein the URL comprises a new URL of the web page that results from a change by a cloud server supporting a service of the application.

3. The image forming apparatus of claim 1, further comprising a communication interface device,
wherein the processor is further to:
determine whether the URL is included in the URL list, and
receive the reliability determination result from an external server through the communication interface device as a response to a request for the external server to perform the reliability determination for the URL when the URL is not in the URL list, the external server providing a reliability determination service.

4. The image forming apparatus of claim 1,
wherein the processor is further to register the URL in the URL list when reliability of the URL is recognized, and
wherein the URL list is stored in the image forming apparatus.

5. The image forming apparatus of claim 4, wherein the processor is further to register the URL in the URL list automatically or according to a user's input.

6. The image forming apparatus of claim 1, wherein the processor is further to reset, at certain intervals, at least one URL in the URL list.

7. The image forming apparatus of claim 1, wherein the processor is further to:
display an error message through the user interface device when reliability of the URL is not recognized, the error message indicating that the web page is not accessible, and
display a notification message through the user interface device when the reliability of the URL is recognized, the notification message indicating that the URL is registered in the URL list.

8. A uniform resource locator (URL) management method in an image forming apparatus, the method comprising:
performing a reliability determination for a URL of a web page to be accessed according to execution of an application;
providing a reliability determination result for the URL through a user interface device; and
managing a URL list of URLs based on the reliability determination result,
wherein the URLs included in the URL list have recognized reliability.

9. The method of claim 8, wherein the URL comprises a new URL of the web page that results from a change by a cloud server supporting a service of the application.

10. The method of claim 8, wherein the performing of the reliability determination for the URL comprises:
determining whether the URL is included in the URL list; and
receiving the reliability determination result from an external server as a response to a request for the external server to perform the reliability determination for the URL when the URL is not in the URL list, the external server providing a reliability determination service.

11. The method of claim 8,
wherein the managing of the URL list comprises registering the URL in the URL list when reliability of the URL is recognized, and
wherein the URL list is stored in an image forming apparatus.

12. The method of claim 11, wherein the registering of the URL comprises registering the URL in the URL list automatically or according to a user's input.

13. The method of claim 8, wherein the managing of the URL list comprises resetting, at certain intervals, at least one URL in the URL list.

14. The method of claim 8, wherein the providing of the reliability determination result comprises:
displaying an error message through the user interface device when reliability of the URL is not recognized, the error message indicating that the web page is not accessible; and
displaying a notification message through the user interface device when the reliability of the URL is recognized, the notification message indicating that the URL is registered in the URL list.

15. A computer-readable storage medium storing instructions executable by a processor, the computer-readable storage medium comprising:
instructions to perform a reliability determination for a uniform resource locator (URL) of a web page to be accessed according to execution of an application;
instructions to provide a reliability determination result for the URL through a user interface device; and
instructions to manage a URL list of URLs based on the reliability determination result, wherein the URLs included in the URL list have recognized reliability.
